(19) United States
(12) Patent Application Publication
(10) Pub. No.: US 2010/0233074 A1
(43) Pub. Date: Sep. 16, 2010

(54) SYNTHETIC METHOD OF TRANSITION METAL OXIDE NANO-PARTICLES

(75) Inventors: Seung-Wan SONG, Daejeon (KR); Ho Kyung LEE, Daejeon (KR); In Young CHOI, Daejeon (KR); Yun-Ho NA, Chungcheongnam-do (KR); Cao Cuong NGUYEN, Hanoi (VN)

Correspondence Address: LOWE HAUPTMAN HAM & BERNER, LLP, 1700 DIAGONAL ROAD, SUITE 300, ALEXANDRIA, VA, 22314, US

(73) Assignee: The Industry & Academic Cooperation in Chugnam National University, Daejeon (KR)

(21) Appl. No.: 12/650,310

(22) Filed: Dec. 30, 2009

(30) Foreign Application Priority Data
Mar. 10, 2009 (KR) 10-2009-0020155

(51) Int. Cl. C01G 41/02; C01G 23/047

(52) U.S. Cl. 423/606; 423/610; 977/773

(57) ABSTRACT

Provided is a method for preparing transition metal oxide nanoparticles from a transition metal as a reactant. The method includes dissolving the transition metal into aqueous hydrogen peroxide to provide peroxi-metallate solution, and then adding a reactive solution containing an alcohol, water and an acid thereto to perform hydrothermal reaction.

More particularly, the method for preparing transition metal oxide particles includes: dissolving transition metal powder as a reactant into aqueous hydrogen peroxide to provide a peroxi-metallate solution with a molar concentration of transition metal of 0.001-0.2 M; adding a reactive solution containing an alcohol, water and an acid to the peroxi-metallate solution to provide a mixed solution; and subjecting the mixed solution to hydrothermal reaction to provide transition metal oxide nanoparticles.

### DETAILED DESCRIPTION OF THE INVENTION

1. Technical Field

The present invention relates to a method for preparing transition metal oxide nanoparticles from transition metals as reactants directly through low-temperature hydrothermal synthesis.

2. Background Art

Transition metal oxide nanoparticles have been used widely and diversely in the fields of physics, chemistry, material engineering, etc., particularly for electronic materials, (photo)catalysts, energy materials, photoelectrode materials, or the like.

Many synthetic processes, including chemical/thermal oxidation processes and sol-gel processes, have been developed to date in order to prepare nano-sized metal oxide particles. Among those processes, the chemical/thermal oxidation processes have problems in that they may cause contamination due to oxidation and may be not amenable to production of uniform nano-sized metal oxide particles.

The most frequently used sol-gel processes are multi-step processes including complicated operations, such as additional high-temperature heat treatment and removal of contaminants, to produce a single phase, and requiring high cost. Moreover, such sol-gel processes use reactants, such as metal chlorides, nitrides and sulfides that have difficulty in handling, cause rapid hydrolysis, and include reactions that are not easily controlled. As a result, it is not possible to obtain nano-sized metal oxide particles with ease from the sol-gel processes.

Further, there has been an attempt to control the hydrolysis and reactivity using a non-aqueous solution during the sol-gel processes. However, since the metal chlorides, nitrides and sulfides, used as reactants, entail a complicated reaction and their reaction is affected by various factors, such an attempt shows poor reproducibility and is not applicable to mass production.

### DISCLOSURE

### Technical Problem

An embodiment of the present invention is directed to providing a method for preparing transition metal oxide nanoparticles having a nano-sized and highly crystalline single phase directly through low-temperature hydrothermal synthesis, wherein the method has easy handling characteristics and high safety, includes a reaction whose rate is easily controllable, avoids a need for additional heat treatment, shows high reproducibility, and is amenable to mass production within a short time.

### Technical Solution

To achieve the object of the present invention, the present invention provides a method for preparing transition metal oxide nanoparticles from a transition metal as a reactant, wherein the transition metal is dissolved into aqueous hydrogen peroxide to provide peroxi-metallate solution, and then a reactive solution containing an alcohol and water is added thereto to perform hydrothermal reaction.

More particularly, the method for preparing transition metal oxide nanoparticles includes: dissolving transition metal powder as a reactant into aqueous hydrogen peroxide to provide a peroxi-metallate solution with a molar concentration of transition metal of 0.001-0.2 M; adding a reactive solution containing an alcohol, water and an acid to the peroxi-metallate solution to provide a mixed solution; and subjecting the mixed solution to hydrothermal reaction to provide transition metal oxide nanoparticles.

Hereinafter, particular embodiments of the method of the present invention will be described in detail. Unless otherwise defined, all terms (including technical and scientific terms) used herein have the same meaning as commonly understood by one of ordinary skill in the art. For the purposes of clarity and simplicity, a detailed description of known functions and configurations incorporated herein will be omitted as it may make the subject matter of the present invention unclear.

The method for preparing transition metal oxide nanoparticles in accordance with an embodiment of the present invention uses a transition metal itself as a reactant, rather than a transition metal precursor, such as a chloride, nitride, sulfide, halide, alkoxide or hydroxide of transition metal, for preparing a transition metal oxide. Such transition metal precursors have significantly decreased stability in air, are susceptible to moisture, do not allow easy control of reaction rate and have no easy handling characteristics. The transition metal itself is dissolved into aqueous hydrogen peroxide to prepare transition metal oxide nanoparticles. More particularly, to prepare the transition metal oxide nanoparticles, the concentration of aqueous hydrogen peroxide and the amount of transition metal introduced into aqueous hydrogen peroxide are controlled so that a peroxi-metallate solution with a molar concentration of transition metal of 0.001-0.2 M (molar concentration based on transition metal ion) is used.

The peroxi-metallate solution is obtained specifically using a transition metal as a reactant and by dissolving the transition metal into aqueous hydrogen peroxide with high concentration. Herein, the aqueous hydrogen peroxide serves not only as an oxidant but also as a complexing agent, and the metal is coordinated with peroxide ligands. In the case of Ti and W, peroxi-metallate complexes, such as TiO₂²⁻ and W₂O₁₁²⁻, are formed, respectively.

The method in accordance with an embodiment of the present invention uses a transition metal itself as a reactant, and thus shows easy handling characteristics, easy controllability in reactivity and high stability, and provides high-purity transition metal oxide nanoparticles containing substantially no impurities. In addition, when two or more different transition metals are dissolved into aqueous hydrogen peroxide, it is possible to obtain an oxide of intermetallic compound of transition metals or solid solutions of two or more transition metal oxides with ease.

In addition, the method uses a peroxi-metallate solution with a concentration of transition metal of 0.001-0.2 M, obtained by dissolving a transition metal into aqueous high-concentration hydrogen peroxide, and thus requires no high-temperature heat treatment or high-temperature firing to remove organic substances. It is possible to obtain transition metal oxide nanoparticles in a one-step mode directly through a low-temperature hydrothermal reaction. It is also possible to obtain transition metal oxide nanoparticles in the form of a single phase, to obtain uniform nano-sized transition metal oxide nanoparticles, and to control the size of transition metal oxide nanoparticles by adjusting the hydrothermal reaction temperature or time. In addition, the method uses reactants having easy handling characteristics in air, unlike alkoxide reactants susceptible to moisture in air and not allowing easy control of hydrolysis rate. Further, the method allows easy control of reactivity, shows high stability during the reaction and reproducibility in terms of the result, and enables production of high-purity transition metal oxide nanoparticles containing no impurities. Moreover, the method allows production of transition metal oxide nanoparticles from any transition metal soluble in aqueous hydrogen peroxide, and thus has no limitation in the selection of transition metal oxide to be obtained. Unlike known processes, the method also avoids high-degree modification in process, selection of additives or additional extraction depending on the transition metal oxide to be obtained. More specifically, the molar concentration of transition metal in the peroxi-metallate solution refers to such a concentration that the transition metal dissolved in the solution reacts with aqueous hydrogen peroxide to form peroxi-metallate complex with ease while avoiding formation of non-controlled transition metal oxides.

The method in accordance with an embodiment of the present invention uses aqueous hydrogen peroxide with a high concentration of 10-50 wt % to form the peroxi-metallate solution. When the transition metal is introduced into aqueous hydrogen peroxide with a concentration less than 10 wt %, dissolution of the transition metal may not be performed easily, or the peroxi-metallate may not be formed. On the contrary, when aqueous hydrogen peroxide with a concentration higher than 50 wt % is used, easy handling or processing characteristics and safety may be degraded.

Then, the peroxi-metallate solution obtained from the above operation is subjected to hydrothermal reaction. To perform the hydrothermal reaction, a reactive solution containing an alcohol, water and an acid is preferably added to the peroxi-metallate solution, wherein the volume ratio of water:alcohol:acid is 1:1-3:0.05-0.2. In the reactive solution, the acid serves as a catalyst during the hydrothermal reaction, and the alcohol serves to reduce the boiling point of water and to increase the reactivity of the reactants during the hydrothermal reaction. In this manner, it is possible to perform the hydrothermal synthesis at a relatively low temperature within a decreased time. The volume ratio of alcohol:water allows preparation of transition metal oxide particles having a nano-scaled narrow particle size distribution. During the hydrothermal reaction, water and the alcohol generate bubbles while they are boiled. By controlling the volume ratio of alcohol:water, it is possible to control the boiling point and the bubble generation degree of the reactive solution, and thus to control the nucleation and growth of the transition metal oxide and to disintegrate the resultant transition metal oxide nanoparticles physically from each other. Particular examples of the alcohol include isopropanol, ethanol or a mixture thereof. Particular examples of the acid include nitric acid, lactic acid or a (C5-C18)alkyl carboxylic acid.

When preparing the mixed solution from the peroxi-metallate solution and the reactive solution, the volume ratio of peroxi-metallate solution:reactive solution is 1:1-3. More particularly, to provide the mixed solution, the peroxi-metallate solution with a molar concentration of transition metal of 0.001-0.2 M is mixed with the reactive solution in the same volumetric amount or in an amount corresponding to three times or less of the volume of the peroxi-metallate solution.

The method in accordance with an embodiment of the present invention allows preparation of transition metal oxide nanoparticles in the form of a single phase directly through the hydrothermal reaction of the mixed solution obtained as described above, at low temperature using a conventional hydrothermal reactor, including an autoclave. More specifically, the hydrothermal reaction is carried out at a temperature of 95-200° C.

Therefore, the method for preparing transition metal oxide nanoparticles avoids a need for additional heat treatment, including high-temperature oxidation after the hydrothermal reaction. The method also avoids a need for heat treatment for adjusting the resultant oxide into a single phase, as well as complicated post-treatment operations to remove organic substances after the hydrothermal reaction. In brief, it is possible to obtain a single phase of transition metal oxide having a uniform nano-scaled particle through hydrothermal reaction at a relatively low temperature of 95-200° C. within a relatively short time of 1-2 hours.

After the hydrothermal reaction, general solid-liquid separation, such as centrifugal separation or filtering, and drying are carried out. As a result, it is possible to obtain transition metal oxide nanopowder.

In the method in accordance with an embodiment of the present invention, the transition metal used as a reactant may be at least one metal selected from the group consisting of scandium (Sc), titanium (Ti), vanadium (V), chrome (Cr), manganese (Mn), iron (Fe), cobalt (Co), nickel (Ni), copper (Co), indium (In), tin (Sn), germanium (Ge), yttrium (Y), zirconium (Zr), niobium (Nb), molybdenum (Mo), tantalum (Ta) and tungsten (W).

As mentioned above, according to another embodiment of the present invention, two or more different transition metals are dissolved into aqueous hydrogen peroxide to provide a peroxi-metallate solution containing two or more peroxi-metallate complexes formed by the reactions between the transition metals and hydrogen peroxide. It is possible to obtain an oxide of intermetallic compound of transition metals or solid solutions of two or more transition metal oxides using the peroxi-metallate solution with ease.

According to still another embodiment of the present invention, aqueous solution of at least one cation selected from the group consisting of Li⁺, Na⁺, K⁺, Rb⁺, Mg²⁺, Ca²⁺, Sr²⁺, Ba²⁺ and Al³⁺ may be added to the peroxi-metallate solution obtained by dissolving a transition metal into aqueous hydrogen peroxide. In this manner, it is possible to obtain binary or higher order composite oxide nanoparticles.

In a specific embodiment, the reactant is titanium (Ti), and titanium.dioxide (TiO₂) nanoparticles with an anatase structure are obtained through the above method. In a variant, the reactant is tungsten (W), and sheet-like tungsten oxide (WO₃) nanoparticles with a hexagonal structure are obtained through the above method.

### ADVANTAGE EFFECTS

The method in accordance with an embodiment of the present invention uses a transition metal itself as a reactant, and thus shows easy handling characteristics, easy controllability in reactivity and high stability, and provides high-purity transition metal oxide nanoparticles containing substantially no impurities. It is possible to obtain transition metal oxide nanoparticles directly through low-temperature hydrothermal reaction while avoiding a need for high-temperature heat treatment or high-temperature firing. It is also possible to obtain a single phase of transition metal oxide and to obtain transition metal oxide nanoparticles having a uniform nano-scaled size. Further, it is possible to control the size of the transition metal oxide nanoparticles by controlling the hydrothermal reaction temperature or time.

### MODE FOR INVENTION

### Example 1

First, Ti metal powder (Aldrich, 268496) is dissolved into 30 wt % aqueous hydrogen peroxide to provide a peroxi-metallate solution with a Ti concentration of 0.14 M. Next, isopropanol, water and nitric acid are mixed in a volume ratio of 1:1:0.1 (isopropanol:water:nitric acid) to provide a reactive solution. Then, 5 mL of the peroxi-metallate solution is mixed with 5 mL of the reactive solution to provide a mixed solution.

The mixed solution is introduced into an autoclave and subjected to hydrothermal reaction in an oven at 120° C. for 2 hours to obtain TiO₂ anatase nanoparticles.

### Example 2

First, W metal powder (Aldrich, 510106) is dissolved into 30 wt % aqueous hydrogen peroxide to provide a peroxi-metallate solution with a W concentration of 0.005 M. Next, isopropanol, water and nitric acid are mixed in a volume ratio of 1:1:0.14 (isopropanol:water:nitric acid) to provide a reactive solution. Then, 36 mL of the peroxi-metallate solution is mixed with 72 mL of the reactive solution to provide a mixed solution.

The mixed solution is introduced into an autoclave and subjected to hydrothermal reaction in an oven at 98° C. for 1 hour to obtain hexagonal structured WO₃ nanoparticles.

FIG. 1 is a scanning electron microscope (SEM) view of titanium dioxide obtained from Example 1. FIG. 2 shows the result of X-ray diffractometry (XRD) of titanium dioxide obtained from Example 1. FIG. 3 is a SEM view of tungsten oxide obtained from Example 2.

As can be seen from FIGS. 1 and 3, nano-sized transition metal oxide particles with a uniform particle size distribution are formed by the method in accordance with an embodiment of the present invention. Even if milling operation, performed generally as the last operation in processes for preparing nanoparticles, is omitted, the method provides nanoparticles that show little aggregation among themselves.

In addition, after the nanoparticles are analyzed by XRD, Example 1 provides highly crystalline titanium dioxide particles having a pure anatase structure (see FIG. 2), and Example 2 provides highly crystalline tungsten oxide (WO₃) having a pure hexagonal structure. It can be also seen from FIGS. 1 to 3 that non-reacted phases or other byproducts are not formed.

While the present invention has been described with respect to the specific embodiments, it will be apparent to those skilled in the art that various changes and modifications may be made without departing from the spirit and scope of the invention as defined in the following claims.

### DESCRIPTION OF DRAWINGS

FIG. 1 is a scanning electron microscope (SEM) view of titanium dioxide obtained from Example 1 in accordance with an embodiment of the present invention.

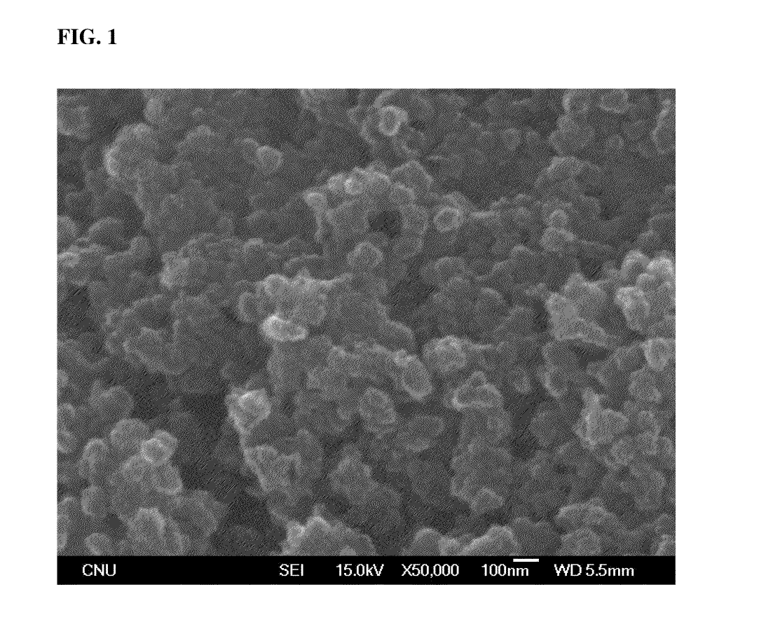

FIG. 2 shows the result of X-ray diffractometry of titanium dioxide obtained from Example 1 in accordance with an embodiment of the present invention.

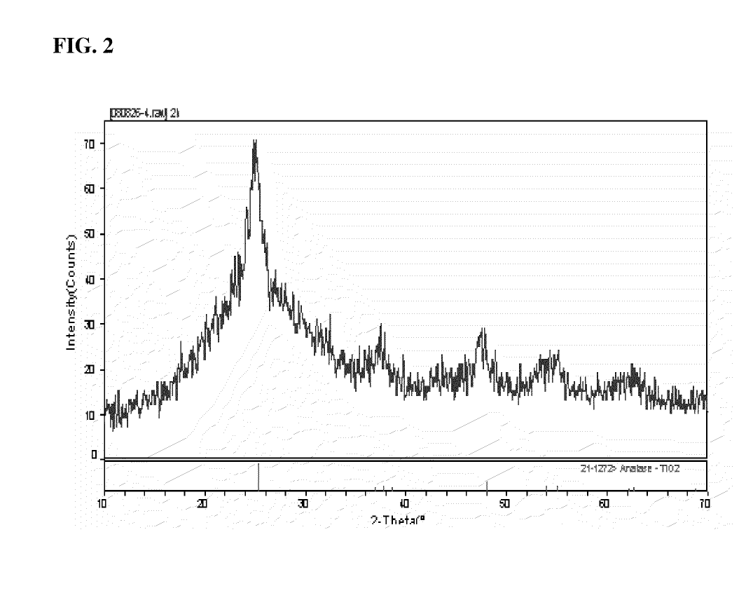

FIG. 3 is a SEM view of tungsten oxide obtained from Example 2 in accordance with an embodiment of the present invention.

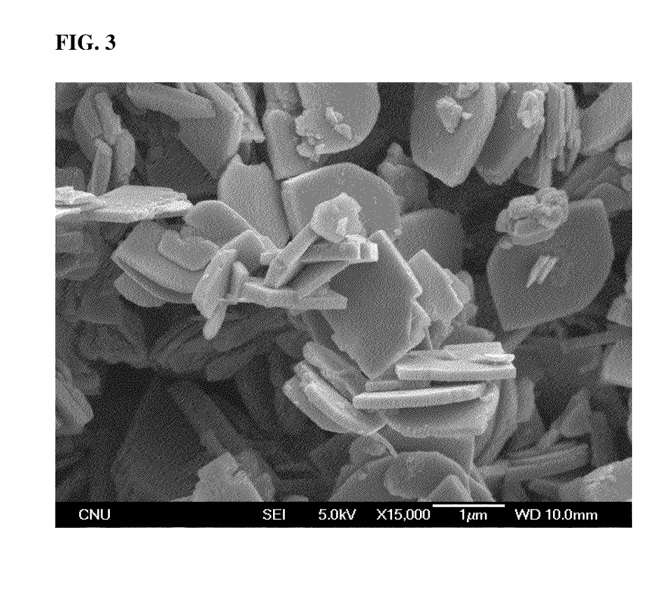

1. A method for preparing transition metal oxide nanoparticles, comprising:
dissolving transition metal powder as a reactant into aqueous hydrogen peroxide to provide a peroxi-metallate solution with a molar concentration of transition metal of 0.001-0.2 M;
adding a reactive solution containing an alcohol, water and an acid to the peroxi-metallate solution to provide a mixed solution; and
subjecting the mixed solution to hydrothermal reaction to provide transition metal oxide nanoparticles.

2. The method according to claim 1, wherein the aqueous hydrogen peroxide used for preparing the peroxi-metallate solution has a concentration of 10-50 wt %.

3. The method according to claim 2, wherein the reactive solution has a volume ratio of water:alcohol:acid of 1:1-3:0.05-0.2.

4. The method according to claim 2, wherein the mixed solution has a volume ratio of peroxi-metallate solution:reactive solution of 1:1-3.

5. The method according to claim 3, wherein the hydrothermal reaction is performed at a temperature of 95-200° C.

6. The method according to claim 1, wherein the reactant is at least one metal selected from the group consisting of scandium (Sc), titanium (Ti), vanadium (V), chrome (Cr), manganese (Mn), iron (Fe), cobalt (Co), nickel (Ni), copper (Co), indium (In), tin (Sn), germanium (Ge), yttrium (Y), zirconium (Zr), niobium (Nb), molybdenum (Mo), tantalum (Ta) and tungsten (W).

7. The method according to claim 6, wherein aqueous solution of at least one cation selected from the group consisting of Li+, Na+, K+, Rb+, Mg2+, Ca2+, Sr2+, Ba2+ and Al3+ is added to the peroxi-metallate solution obtained by dissolving the transition metal powder into aqueous hydrogen peroxide, thereby forming binary or higher order composite oxide nanoparticles in the hydrothermal reaction.

8. The method according to claim 2, wherein the reactant is at least one metal selected from the group consisting of scandium (Sc), titanium (Ti), vanadium (V), chrome (Cr), manganese (Mn), iron (Fe), cobalt (Co), nickel (Ni), copper (Co), indium (In), tin (Sn), germanium (Ge), yttrium (Y), zirconium (Zr), niobium (Nb), molybdenum (Mo), tantalum (Ta) and tungsten (W).

9. The method according to claim 3, wherein the reactant is at least one metal selected from the group consisting of scandium (Sc), titanium (Ti), vanadium (V), chrome (Cr), manganese (Mn), iron (Fe), cobalt (Co), nickel (Ni), copper (Co), indium (In), tin (Sn), germanium (Ge), yttrium (Y), zirconium (Zr), niobium (Nb), molybdenum (Mo), tantalum (Ta) and tungsten (W).

10. The method according to claim 4, wherein the reactant is at least one metal selected from the group consisting of scandium (Sc), titanium (Ti), vanadium (V), chrome (Cr), manganese (Mn), iron (Fe), cobalt (Co), nickel (Ni), copper (Co), indium (In), tin (Sn), germanium (Ge), yttrium (Y), zirconium (Zr), niobium (Nb), molybdenum (Mo), tantalum (Ta) and tungsten (W).

11. The method according to claim 5, wherein the reactant is at least one metal selected from the group consisting of scandium (Sc), titanium (Ti), vanadium (V), chrome (Cr), manganese (Mn), iron (Fe), cobalt (Co), nickel (Ni), copper (Co), indium (In), tin (Sn), germanium (Ge), yttrium (Y), zirconium (Zr), niobium (Nb), molybdenum (Mo), tantalum (Ta) and tungsten (W).
